(19) United States
(12) Patent Application Publication
(10) Pub. No.: US 2011/0102465 A1
(43) Pub. Date: May 5, 2011

(54) IMAGE PROCESSOR, ELECTRONIC DEVICE INCLUDING THE SAME, AND IMAGE PROCESSING METHOD

(76) Inventors: Sung Jin Cho, Seoul (KR); Jong Ho Roh, Yongin-si (KR)

(21) Appl. No.: 12/908,465

(22) Filed: Oct. 20, 2010

(30) Foreign Application Priority Data
Nov. 3, 2009 (KR) 10-2009-0105513

(51) Int. Cl. G09G 5/00

(52) U.S. Cl. 345/657

(57) ABSTRACT

An image processor includes a rotation block and a scaler which share a line buffer block with each other. The image processor receives rearranged pixel data from a memory unit based on rotation information for generating a rotated image and performs scaling on the rearranged pixel data.

### CROSS-REFERENCE TO RELATED APPLICATIONS

This application claims the benefit of Korean Patent Application No. 10-2009-0105513 filed on Nov. 3, 2009, in the Korean Intellectual Property Office, the disclosure of which is incorporated by reference herein in its entirety.

### BACKGROUND

The inventive concept relates to image processing techniques, and more particularly, to image processors for rotating and/or scaling a source image stored in a memory, image processing methods, and electronic devices including image processors.

Image processors for processing multimedia data may perform image processing on various multimedia sources such as a Joint Photographic Experts Group (JPEG) source, a Moving Picture Experts Group (MPEG) source, an H.264 source, and/or other types of sources. The processed images may be displayed on display devices, such as liquid crystal displays (LCDs). In particular, an image processor may process multimedia sources so that they can be displayed on a display device that may be restricted to displaying images that have particular resolutions, formats, sizes, etc.

Such image processor may include a rotator which rotates an image and a scaler which resizes an image by scaling the image in horizontal and/or vertical directions. According to conventional image processing methods, a rotator and a scaler are usually implemented separately. When the rotator and the scaler are separated in the image processor, at least three or four memory accesses may be required for image processing. In particular, when a moving image is processed, bus bandwidth consumption may be very high depending on the size and the format of the image.

To overcome those problems, image processors in which a rotator and a scaler are unified and have separate line buffers have been developed. However, the separated line buffer structure may result in an increase in the number of components needed for image processing, and may cause a problem in that the size of an input image may need to be considered with respect to both the rotator and the scaler.

### SUMMARY

Some embodiments of the present invention provide image processors for enabling a rotator and a scaler to share a line buffer with each other to reduce gate count and increase image processing performance with respect to multimedia sources having various resolutions, electronic devices including the same, and image processing methods.

According to some embodiments of the present invention, there is provided an image processor including a rotation block, a line buffer block, and a scaling block. The rotation block may receive rearranged pixel data of a source image from a memory unit based on addresses generated in response to rotation information and output the rearranged pixel data. The line buffer block may receive the rearranged pixel data from the rotation block and to store the rearranged pixel data. The scaling block may scale the rearranged pixel data output from the line buffer block in horizontal and vertical directions.

The rotation block may include an address generator and a direct memory access unit. The address generator may generate the addresses for generating a rotated image in response to the rotation information. The direct memory access unit may fetch and output pixel data corresponding to the addresses in the source image.

According to other embodiments of the present invention, there is provided an image processing method including receiving rearranged pixel data of a source image from a memory unit based on addresses generated in response to rotation information and outputting the rearranged pixel data; storing the rearranged pixel data; and scaling the rearranged pixel data in horizontal and vertical directions. Receiving and outputting the rearranged pixel data of the source image may include rearranging pixel data of the source image stored in the memory unit based on the rotation information and generating the addresses for generating a rotated image; and fetching and outputting pixel data corresponding to the addresses in the source image.

The image processing method may be realized by executing a computer program for executing the image processing method stored in a computer readable recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an electronic device including an image processor according to some embodiments of the inventive concept;

FIG. 2 is a diagram showing a source image stored in a memory unit illustrated in FIG. 1 and an image stored in a line buffer block illustrated in FIG. 1;

FIG. 3 is a diagram showing a procedure in which pixel data is input to and output from the line buffer block of the image processor in some embodiments of the inventive concept;

FIG. 4 is a diagram showing a procedure in which pixel data is input to and output from a line buffer block of an image processor in a comparative example;

FIG. 5 is a diagram showing an image rotation procedure using input rotation in some embodiments of the inventive concept;

FIG. 6 is a diagram showing an image rotation procedure using output rotation in a comparative example; and

FIG. 7 is a flowchart of an image processing method according to some embodiments of the inventive concept.

### DETAILED DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

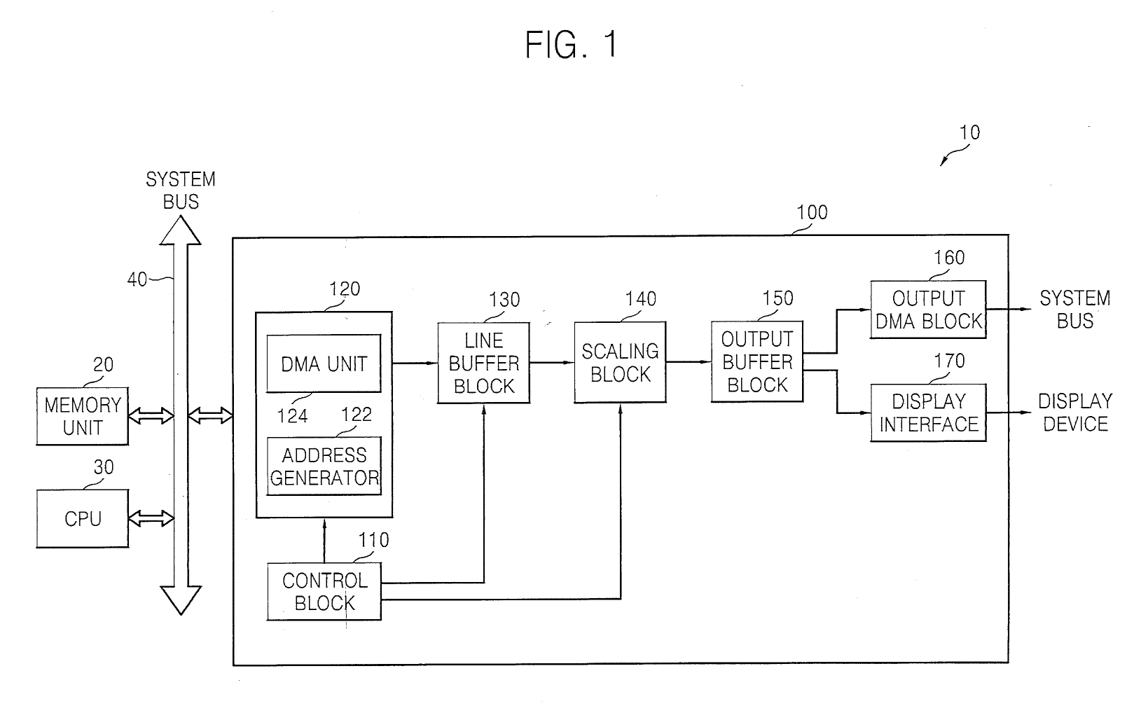

FIG. 1 is a block diagram of an electronic device 10 including an image processor 100 according to some embodiments of the present invention. The electronic device 10 may be a camera for executing image processing for image display, TV, LCD, or PDP, and may, for example, be a portable electronic device such as a personal digital assistant (PDA), a cellular telephone, an MP3 player, a portable multimedia player (PMP), an automotive navigation system, a mobile Internet device (MID), etc. But, the electronic device 10 according to some embodiments of the present invention is not restricted to the above devices.

The electronic device 10 includes a memory unit 20, a central processing unit (CPU) 30, a system bus 40, and the image processor 100.

The memory unit 20 stores a variety of data including a multimedia source to be processed by the image processor 100. As used herein, the term “multimedia source” includes an image to be processed, such as a still image and/or a frame from a video signal/file. The CPU 30 performs various operations necessary for the operation of the electronic device 10. The image processor 100 processes an image received from the memory unit 20, so that a display device can display the image, and then outputs the image to the memory unit 20 via the system bus 40 or to the display device. The memory unit 20, the CPU 30, and the image processor 100 are connected to one another through the system bus 40.

The image processor 100 includes a control block 110, a rotation block 120, a line buffer block 130, a scaling block 140, an output buffer block 150, an output direct memory access (DMA) block 160, and a display interface 170. The rotation block 120 receives pixel data of a source image from the memory unit 20. The pixel data is rearranged as it is received based on addresses generated in response to rotation information received from the control block 110. The rotation block 120 then outputs the pixel data.

Instead of rotating a source image after receiving the source image from the memory unit 20, the rotation block 120 directly receives pixel data having an address in accordance with a rotated image, that is, pixel data corresponding to a rearranged source image address in accordance with the rotated image from the memory unit 20 and outputs the pixel data to the line buffer block 130. Such operation of directly receiving pixel data corresponding to a rotated image from the memory unit 20 is referred to as “input rotation”. An operation of rotating a source image after receiving the source image from the memory unit 20 is referred to as “output rotation”.

The rotation block 120 includes an address generator 122 and a DMA unit 124. The address generator 122 rearranges pixel data in a source image stored in the memory unit 20 based on rotation information received from the control block 110 and generates addresses for generating a rotated image. The DMA unit 124 fetches the pixel data corresponding to the address in the source image and outputs the pixel data.

Rotation information is generated by the control block 110 based on a command received from the system bus 40 and may include various information used to process source data stored in the memory unit 20. The rotation information may include information about normal mode, mirroring mode, and rotation mode and information attendant on the combination of the modes. In the normal mode, the memory unit 20 is linearly scanned to output pixel data. In the mirroring mode, the memory unit 20 is scanned to output pixel data to be in accordance with an image mirrored along a certain axis (e.g., an X-axis, a Y-axis, or an XY axis). In the rotation mode, the memory unit 20 is scanned to output pixel data in accordance with an image rotated by a predetermined angle (e.g., 0, 90, 180, or 270 degrees).

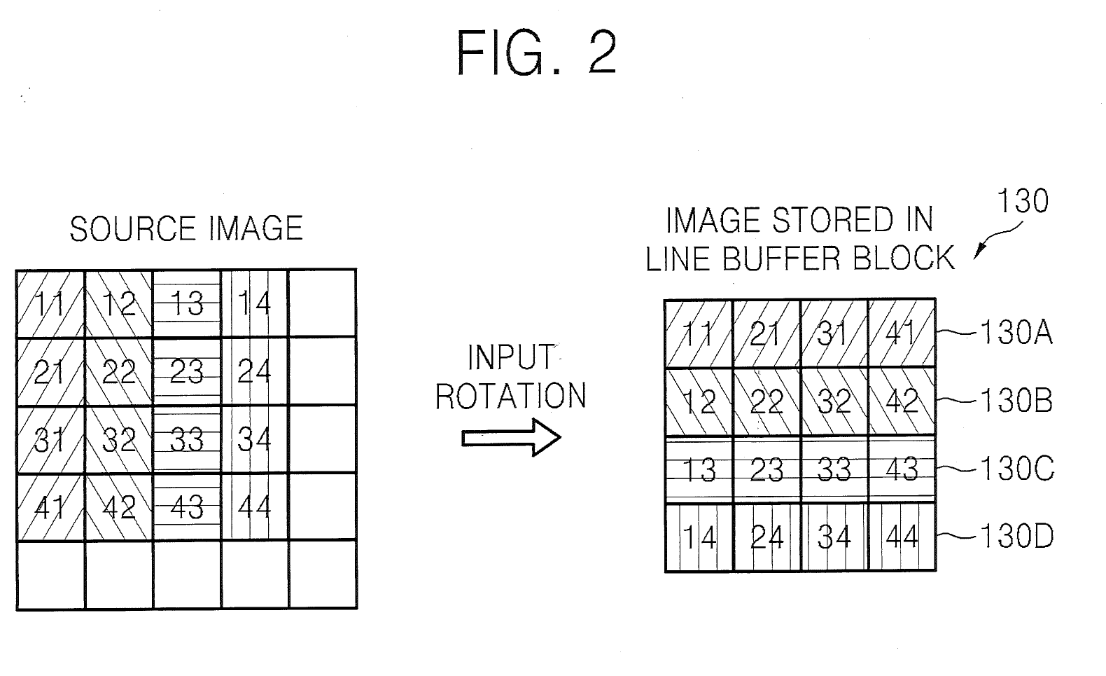

The line buffer block 130 temporarily stores rearranged pixel data output from the rotation block 120. The rearranged pixel data output to the line buffer block 130 is received from the memory unit 20 using input rotation. FIG. 2 is a diagram showing a source image stored in the memory unit 20 illustrated in FIG. 1 and an image stored in the line buffer block 130 illustrated in FIG. 1. Referring to FIG. 2, the source image is rotated 90 degrees clockwise an mirrored in the line buffer block 130.

In other words, pixel data corresponding to addresses 11, 21, 31, and 41 at the first column of the source image are rearranged to a first line buffer 130A of the line buffer block 130. Pixel data corresponding to addresses 12, 22, 32, and 42 at the second column of the source image are rearranged to a second line buffer 130B of the line buffer block 130. Pixel data corresponding to addresses 13, 23, 33, and 43 at the third column of the source image are rearranged to a third line buffer 130C of the line buffer block 130. Pixel data corresponding to addresses 14, 24, 34, and 44 at the fourth column of the source image are rearranged to a fourth line buffer 130D of the line buffer block 130. Numerals marked on the source image and the image stored in the line buffer block 130 denote addresses of pixel data.

The line buffer block 130 includes a plurality of line buffers storing rearranged pixel data. Each of the line buffers may have a size corresponding to a single line of a maximum size image supported by the image processor 100. In other words, each line buffer can store pixel data corresponding to a single line of a maximum size image output by the image processor 100.

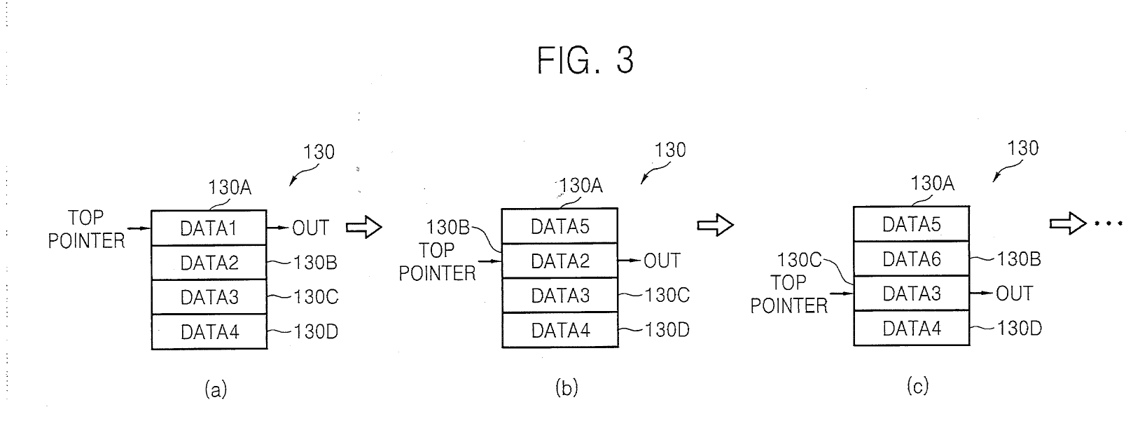

The line buffer block 130 may sequentially output rearranged pixel data stored in the line buffers using a circular queue. In other words, the rearranged pixel data output from the rotation block 120 may be stored in the line buffer block 130 in a circular way using the circular queue. The operation of the line buffer block 130 outputting pixel data in circular queue will be described in detail with reference to FIG. 3 below. FIG. 3 is a diagram showing a procedure in which pixel data is input to and output from the line buffer block 130 of the image processor 100 in some embodiments of the present invention.

Referring to FIG. 3, as a top pointer moves in the line buffer block 130, pixel data stored in the line buffers 130A through 130D are sequentially output. After pixel data is output from each of the line buffers 130A through 130D, subsequent pixel data are sequentially input to the line buffers 130A through 130D. In detail, at stage (a), pixel data DATA1 is output from the first line buffer 130A at which the top pointer is positioned. At stage (b), subsequent pixel data DATA5 is input to the first line buffer 130A, from which the pixel data DATA1 has been output, and pixel data DATA2 is output from the second line buffer 130B as the top pointer moves to the second line buffer 130B. At stage (c), subsequent pixel data DATA6 is input to the second line buffer 130B, from which the pixel data DATA2 has been output, and pixel data DATA3 is output from the third line buffer 130C as the top pointer moves to the third line buffer 130C. In this manner, pixel data is input to and output from the line buffer block 130.

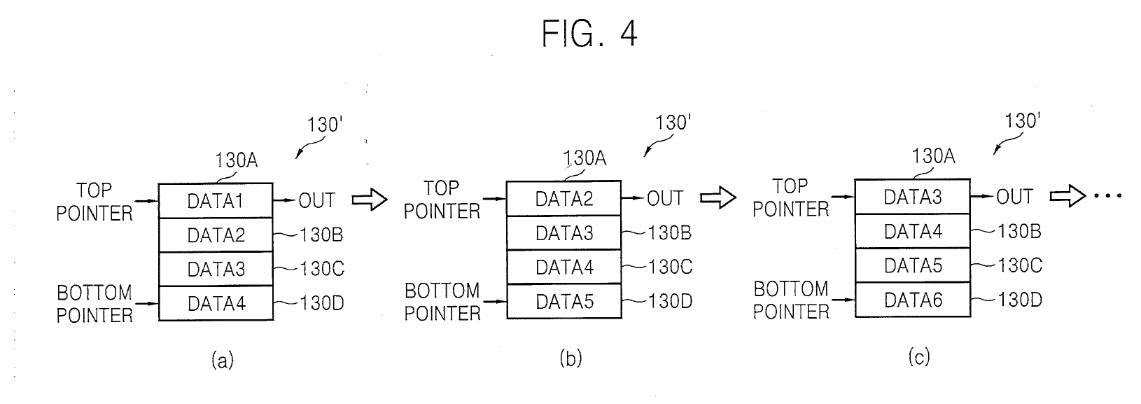

FIG. 4 is a diagram showing a procedure in which pixel data is input to and output from a line buffer block 130′ of an image processor in a comparative example. The data input/output of the line buffer block 130′ illustrated in FIG. 4 is performed using a shifting method. Referring to FIG. 4, a top pointer and a bottom pointer are fixed on the first line buffer 130A and the fourth line buffer 130D, respectively, in the line buffer block 130′ and pixel data is always output from the first line buffer 130A at which the top pointer is positioned.

In detail, at stage (a), pixel data DATA1 is output from the first line buffer 130A at which the top pointer is positioned. At stage (b), pixel data stored in the line buffer block 130′ shifts to an adjacent line buffer toward the top pointer; pixel data DATA2 is output from the first line buffer 130A at which the top pointer is positioned; and subsequent pixel data DATA5 is input to the fourth line buffer 130D at which the bottom pointer is positioned. At stage (c), pixel data stored in the line buffer block 130′ shifts to the adjacent line buffer toward the top pointer; pixel data DATA3 is output from the first line buffer 130A at which the top pointer is positioned; and subsequent pixel data DATA6 is input to the fourth line buffer 130D at which the bottom pointer is positioned. In this manner, pixel data is input to and output from the line buffer block 130′.

When pixel data is input to and output from the line buffer block 130 using the circular queue according to some embodiments of the present invention, output of one pixel data and input of one pixel data are performed at one stage. However, when the shifting method is used, shifting of three pixel data and input of one pixel data are performed in one stage. Accordingly, the image processor 100 using the circular queue simplifies the operation and consumes less electric power as compared to the image processor using the shifting method.

The scaling block 140 scales the rearranged pixel data output from the line buffer block 130 in both horizontal and vertical directions. Since the scaling block 140 directly performs a scaling operation on pixel data, which is stored in the line buffer block 130 using the input rotation and output from the line buffer block 130, the scaling block 140 shares a line buffer with the rotation block 120. Therefore, the image processor 100 has smaller chip size and less power consumption than conventional image processors in which a rotator and a scaler have their own separate line buffers.

The output buffer block 150 buffers pixel data output from the scaling block 140. The output DMA block 160 may output buffered pixel data (i.e., a rotated image) output from the output buffer block 150 to the memory unit 20. Then, the memory unit 20 stores the rotated image. The display interface 170 receives pixel data (i.e., an image processed to be suitable for the resolution of a display device) from the output buffer block 150 and outputs the pixel data to the display device.

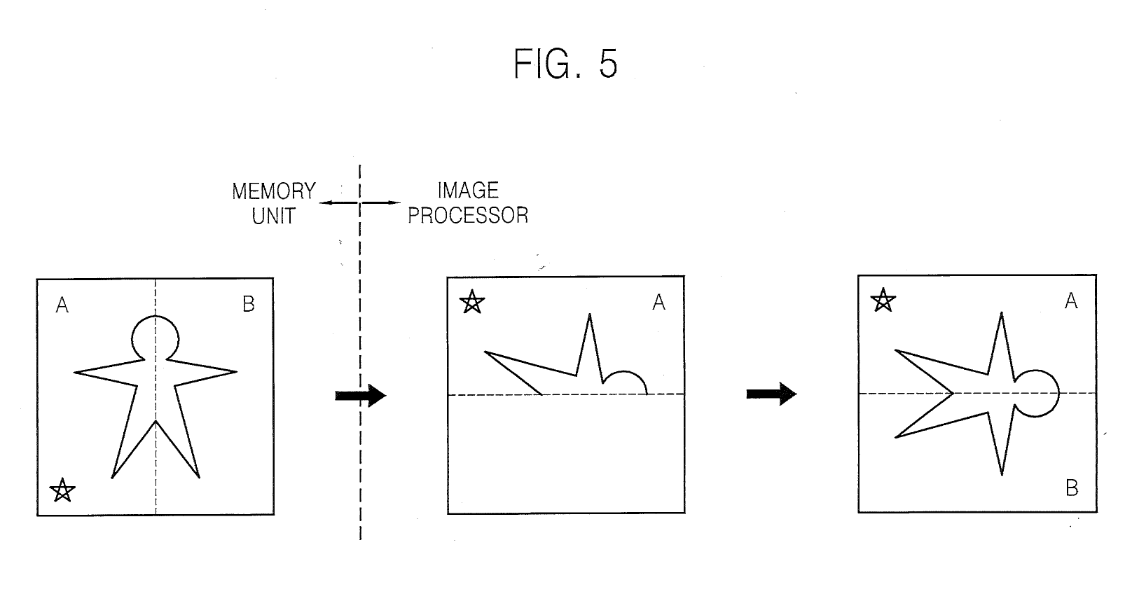

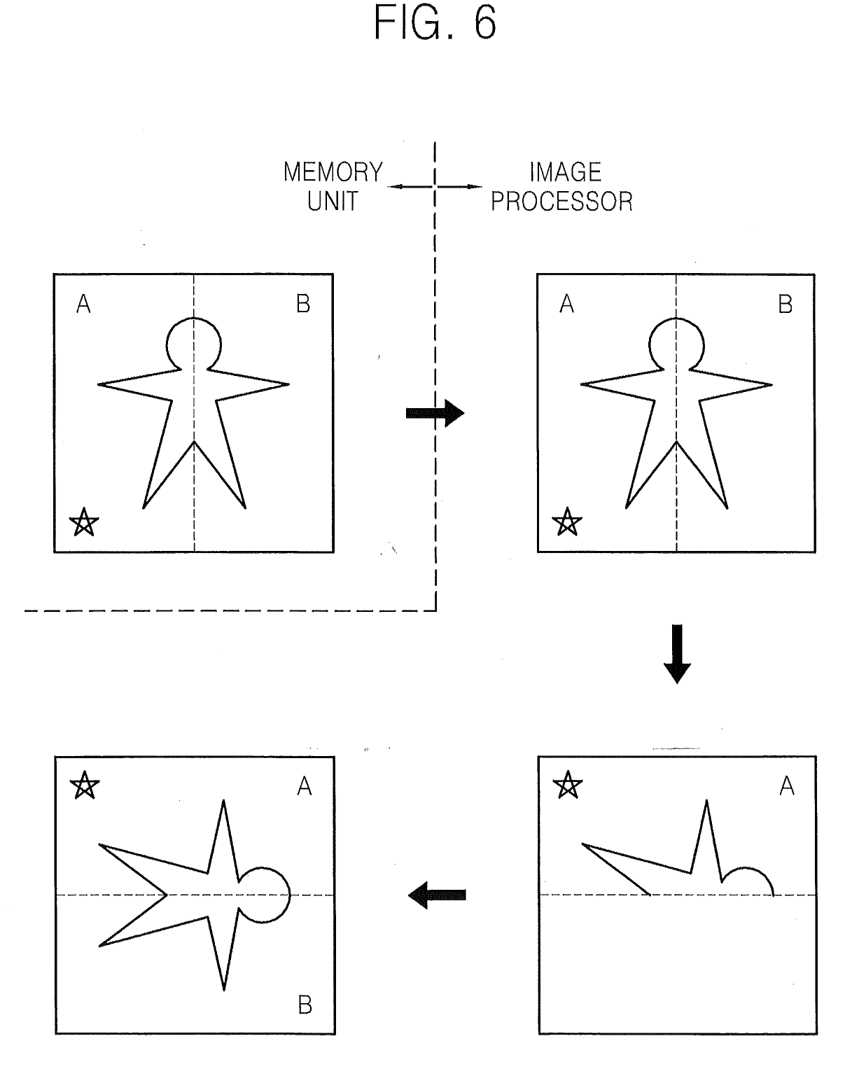

FIG. 5 is a diagram showing an image rotation procedure of the image processor 100 using the input rotation in some embodiments of the present invention. FIG. 6 is a diagram showing an image rotation procedure of an image processor using the output rotation in a comparative example. Here, it is assumed that the capacity of a line buffer block is half of the size of a source image stored in a memory unit.

Referring to FIG. 5, the image processor 100 receives pixel data corresponding to the left portion of a source image in a 90-degree clockwise rotated state and then receives pixel data corresponding to the right portion of the source image in a 90-degree clockwise rotated state in accordance with the input rotation. Referring to FIG. 6, however, the image processor using the output rotation receives an entire source image from a memory unit, then rotates pixel data corresponding to the left portion of the source image 90 degrees clockwise, and then rotates pixel data corresponding to the right portion of the source image 90 degrees clockwise.

When the image processor using the output rotation illustrated in FIG. 6 does not have enough space to store an entire source image, it can still rotate and store the source image in a memory unit but cannot rotate and provide the source image stored in the memory unit to a display device in real time. Unlike the image processor using the output rotation, the image processor 100 using the input rotation does not require a storage space for receiving an entire source image even when it rotates and outputs the source image in real time.

The image processor 100 according to some embodiments of the present inventive concept may be packed in various types of packages. For example, the various packages may include PoP (Package on Package), Ball grid arrays (BGAs), Chip scale packages (CSPs), Plastic Leaded Chip Carrie r(PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and/or any other type of package now existing or later developed.

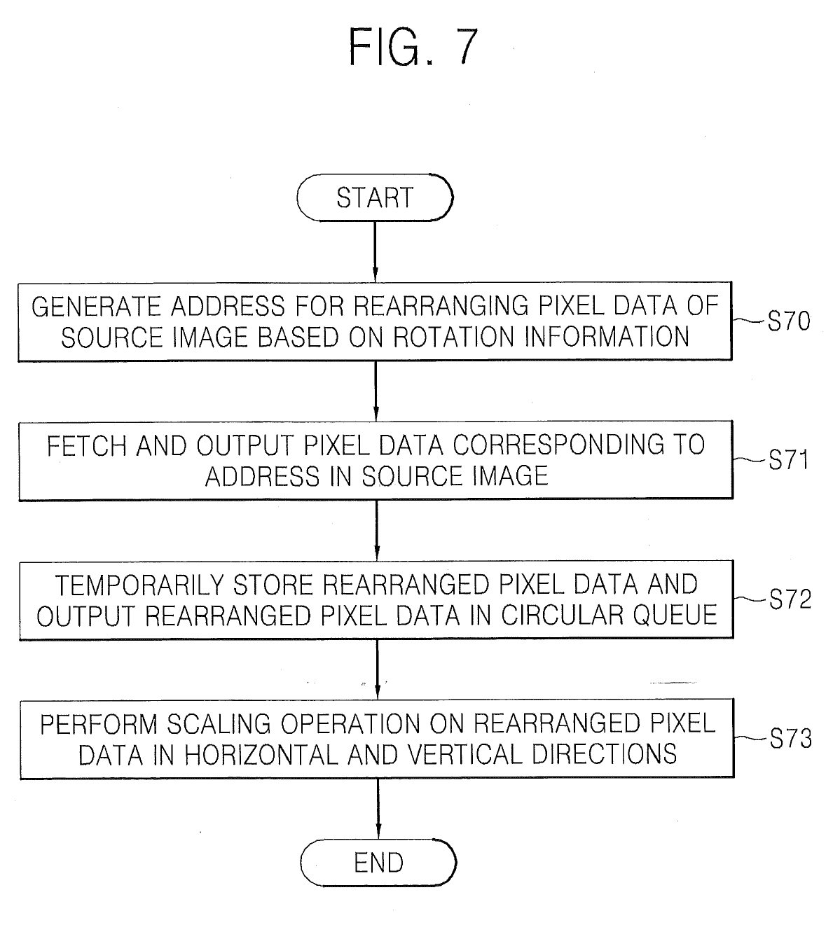

FIG. 7 is a flowchart of an image processing method according to some embodiments of the present invention. Referring to FIGS. 1 and 7, the control block 110 included in the image processor 100 generates rotation information used to process a source image stored in the memory unit 20 based on a command received from the system bus 40 and the address generator 122 of the rotation block 120 generates an address for rearranging pixel data of the source image in a rotated image based on the rotation information in operation S70.

Thereafter, the DMA unit 124 fetches pixel data corresponding to the address from the source image in response to the address and outputs the pixel data in operation S71. This means that the pixel data is directly received in a rotated state from the memory unit 20 according to the input rotation. Next, the line buffer block 130 temporarily stores the rearranged pixel data output from the DMA unit 124 and outputs the rearranged pixel data in circular queue in operation S72. The scaling block 140 performs a scaling operation on the rearranged pixel data output from the line buffer block 130 in horizontal and vertical direction in operation S73.

As described above, according to some embodiments of the present invention, since an image processor directly receives an image in a rotated and/or mirrored state from a memory unit, it does not need internal memory for storing the entire image from the memory unit. In addition, as a rotator and a scaler share a line buffer with each other in the image processor, the chip size of the image processor and power consumption for image processing are reduced compared to conventional image processing techniques. Furthermore, image processing performance for real-time image display is increased.

Some embodiments of the present inventive concept can be embodied in hardware, software, firmware or combination thereof. When the image processing method according to some embodiments of the present inventive concept is embodied in software, it can be embodied as computer readable codes or programs on a computer readable recording medium. The computer readable recording medium is any data storage device that can store data which can be thereafter read by a computer system. Examples of the computer readable recording medium may includes read-only memory (ROM), random-access memory (RAM), electrically erasable programmable ROM (EEPROM), and flash memory.

While the present invention has been particularly shown and described with reference to exemplary embodiments thereof, it will be understood by those of ordinary skill in the art that various changes in forms and details may be made therein without departing from the spirit and scope of the present invention as defined by the following claims.

What is claimed is:

1. An image processor comprising:
a rotation block configured to receive rearranged pixel data of a source image from a memory unit based on addresses generated in response to rotation information, and to output the rearranged pixel data;
a line buffer block configured to receive the rearranged pixel data from the rotation block and to store the rearranged pixel data; and
a scaling block configured to scale the rearranged pixel data output from the line buffer block in horizontal and vertical directions.

2. The image processor of claim 1, wherein the rotation block comprises:
an address generator configured to generate the addresses for generating a rotated image in response to the rotation information; and
a direct memory access unit configured to fetch and output pixel data corresponding to the addresses in the source image.

3. The image processor of claim 1, wherein the rotation information comprises information about linearly outputting the source image, information about rotating the source image at a predetermined angle, and/or information about mirroring the source image along a predetermined axis.

4. The image processor of claim 1, wherein the line buffer block comprises a plurality of line buffers, and is configured to sequentially output rearranged pixel data stored in the plurality of line buffers in circular queue.

5. The image processor of claim 4, wherein each of the line buffers has a size corresponding to a single line of a maximum size image supported by the image processor.

6. The image processor of claim 1, wherein the rearranged pixel data output from the rotation block is stored in the line buffer block in circular queue.

7. An image processor comprising:
a rotation block configured to receive rearranged pixel data of a source image from a memory unit based on an address generated in response to rotation information, and to output the rearranged pixel data;
a line buffer block comprising a plurality of line buffers configured to store rearranged pixel data and to sequentially output the rearranged pixel data stored in the plurality of line buffers in circular queue; and
a scaling block configured to scale the rearranged pixel data output from the line buffer block in horizontal and vertical directions,
wherein the rotation block comprises:
an address generator configured to generate the address for generating a rotated image in response to the rotation information; and
a direct memory access unit configured to fetch and output pixel data corresponding to the address in the source image.

8. The image processor of claim 7, wherein the rotation information comprises information about linearly outputting the source image, information about rotating the source image at a predetermined angle, and/or information about mirroring the source image along a predetermined axis.

9. The image processor of claim 7, wherein each of the line buffers has a size corresponding to a single line of a maximum size image supported by the image processor.

10. An electronic apparatus comprising the image processor of claim 7.

11. An image processing method comprising:
receiving rearranged pixel data of a source image from a memory unit based on addresses generated in response to rotation information and outputting the rearranged pixel data;
storing the rearranged pixel data; and
scaling the rearranged pixel data in horizontal and vertical directions.

12. The image processing method of claim 11, wherein receiving and outputting the rearranged pixel data of the source image comprises:
rearranging pixel data of the source image stored in the memory unit based on the rotation information and generating the addresses for generating a rotated image; and
fetching and outputting pixel data corresponding to the addresses in the source image.

13. The image processing method of claim 11, wherein the rotation information comprises information about linearly outputting the source image, information about rotating the source image at a predetermined angle, and/or information about mirroring the source image along a predetermined axis.

14. The image processing method of claim 11, wherein the storing the rearranged pixel data comprises sequentially outputting the rearranged pixel data in a plurality of line buffers in circular queue.

15. The image processing method of claim 14, wherein each of the line buffers has a size corresponding to a single line of a maximum size image supported by the image processing method.

16. The image processing method of claim 11, further comprising sequentially outputting the rearranged pixel data in circular queue.

17. An image processing method comprising:
receiving and rearranging pixel data of a source image from a memory unit based on an address generated in response to rotation information;
storing the rearranged pixel data in a plurality of line buffers;
sequentially outputting the rearranged pixel data from the plurality of line buffers in circular queue; and
scaling the rearranged pixel data in horizontal and vertical directions,
wherein receiving the rearranged pixel data of the source image comprises:
rearranging pixel data of the source image stored in the memory unit in response to the rotation information and generating the address for generating a rotated image; and
fetching and outputting pixel data corresponding to the address in the source image.

18. The image processing method of claim 17, wherein the rotation information comprises information about linearly outputting the source image, information about rotating the source image at a predetermined angle, and/or information about mirroring the source image along a predetermined axis.

19. The image processing method of claim 17, wherein each of the line buffers has a size corresponding to a single line of a maximum size image supported by the image processing method.

20. A computer readable medium storing a computer program to execute the image processing method of claim 17.
